(19) United States
(12) Patent Application Publication
(10) Pub. No.: US 2021/0332270 A1
(43) Pub. Date: Oct. 28, 2021

(54) METHOD FOR PRODUCING A HIGH TEMPERATURE RESISTANT, HEAT INSULATING, AND FIREPROOF COMPOSITE GLUE COMPOSED OF AN AEROGEL AND AN INORGANIC FIBER AND THE APPLICATION OF THE RELATED PRODUCT

(71) Applicant: Taiwan Aerogel Technology Material Co., Ltd., Tainan City (TW)

(72) Inventors: Jean-Hong CHEN, Tainan City (TW); Shiu-Shiu CHEN, Tainan City (TW); Sheng-Hong PONG, Tainan City (TW); Yang-Duan LI, Tainan City (TW)

(21) Appl. No.: 16/859,342

(22) Filed: Apr. 27, 2020

(51) Int. Cl. C09J 11/08; C09J 1/00; C09J 1/02; C09J 11/04

(52) U.S. Cl. CPC C09J 11/08; C09J 11/04; C09J 1/02; C09J 1/00

(57) ABSTRACT

A method for producing a composite glue composed of an aerogel, an inorganic fiber, and an inorganic adhesive includes the following steps of: (1) mixing step, (2) hydrolysis step, (3) condensation step, (4) aging step, (5) high-temperature solvent replacement step, (6) evaporation and drying step, and (7) composition step. The obtained product thereof is a viscous composite glue composed of the aerogel, and the total content of the aerogel and an inorganic fiber is of 25-90 wt % after dried. Additionally, the obtained product can be used at a high temperature of more than 600° C., and has no phenomena of inorganic material decomposition and carcinogen production.

### FIELD OF THE INVENTION

The present invention relates to a method for producing a high temperature resistant, heat insulating and fireproof composite glue composed of an aerogel, an inorganic fiber, and an inorganic adhesive, and the application of the related product thereof, and in particular, to the composite gel and the related product made through the method described both having the characteristics of resistance to a high temperature exceeding 800° C.

### BACKGROUND OF THE INVENTION

Aerogel refers to a porous material having a geometrical network structure, and it is a high-tech product with the characteristics of low density (0.003˜0.2 g/cm³), high specific area (500˜2,000 m²/g) and low thermal conductivity (0.02˜0.036 W/mK). In addition, the porosity of aerogel reaches above 95% and its internal contains a great amount of air; therefore, it has an overall transparent appearance and the characteristics of low thermal conductivity coefficient, low acoustic transmission speed and low dielectric constant, making aerogel as a material with the properties of excellent heat insulation, soundproof, electrical insulation, absorbing and filtering material. Nevertheless, to achieve the foregoing functions during use, it is necessary to uniformly distribute aerogel onto a substrate of rockwool, glass fiber cotton or carbon fiber cotton in order to form an aerogel heat insulating blanket. Common aerogel heat insulating blankets are subject to the problem of loose powder, and a lot of aerogel blankets have an application temperature below 200° C. and it is not resistant to higher temperature up to above 300° C. In addition, the commercially available aerogel heat insulating blankets capable of being used under the high temperature of 300° C. are known to release toxic gas or odor, and after a certain period of use, such blankets tend to have obvious degradation of the organic components in the hydrophobic aerogel. Therefore, during the replacement process, a lot of aerogel degrading materials or dust are generated that are very likely to cause personal health injury and environmental contamination.

A known aerogel production method refers to the sol-gel synthetic method. It mainly mixes the precursors, e.g. alkoxysilane, methyl silicate or sodium silicate, with an organic solvent, followed by addition of acid catalyst in order to perform the hydrolysis. For a certain period of hydrolysis, basic catalyst is further added to perform the condensation, and sol is gradually formed during the condensation process. The molecules in the sol continue to perform bonding, and semisolid polymeric gel is gradually formed. Next, after a period of aging, the gel then transforms from the semisolid structure into a geometrical network structure of a stable structure. Finally, ethanol, n-butanol, or n-propanol is used to perform the solvent replacement, following which the solvent of n-hexane or cyclohexane is further used to perform the solvent replacement. Then, the supercritical drying technique is applied to dry off the solvent inside the geometrical network structure in order to obtain porous aerogel powder that is dry and hydrophobic.

The hydrophobic aerogel heat insulating blanket currently used also adopts the sol-gel synthetic method as a start of its manufacturing process. First, it mainly mixes alkoxysilane e.g. methyltrimethoxysilane (MTMS) or methyltriethoxysilane (MTES), with an organic solvent, followed by the addition of a basic catalyst to perform the hydrolysis. For a certain period of hydrolysis, condensation process is performed, and gel is gradually formed during the condensation process, following which drying under room temperature and room pressure or under high temperature and room pressure is performed. In addition, the sol-gel synthetic method can also mix alkoxysilane, e.g. tetraethoxysilane (TEOS) or tetramethoxysilane (TMOS), with an organic solvent, followed by the addition of an acid catalyst to perform the hydrolysis. For a certain period of hydrolysis, a basic catalyst is further added to perform the condensation, and it is able to gradually form a geometrical network structure of a stable structure during the condensation process. Next, ethanol, n-butanol, or n-propanol is used to perform the solvent replacement first, following which the solvent of n-hexane or cyclohexane is further used to perform the solvent replacement. Then, trimethyl chlorosilane or hydrophobic alkoxysilane is used to perform the hydrophobic modification in order to allow the hydrophobic functional group to form chemical bonding with the geometrical network structure. Furthermore, the room pressure drying technique is applied to dry off the solvent inside the geometrical network structure in order to obtain a dry porous aerogel block. Finally, the aerogel powder derived therefrom is uniformly sprayed onto an inorganic cotton blanket, followed by the coating of silicon oil, and needled formation method is adopted to form a multilayer aerogel heat insulating blanket. However, it is found that when the aforementioned hydrophobic aerogel and the multilayer aerogel heat insulating blanket formed are used under a temperature reaching 350° C., degradation starts to occur, and a large amount of toxic and organic substances are released; consequently, such materials cannot be used for industrial applications. Furthermore, since the numerous times of solvent replacements and are required and use of organic substances for modification is necessary during the manufacturing process of the aforementioned hydrophobic aerogel, the overall technique can be costly and time consuming such that it is not cost effective.

For high temperature resistant and heat insulating ceramic plates, such as a foamed ceramic composite floor-heating brick and preparation method thereof disclosed in Chinese Invention Patent Publication No. CN105135507A, it uses a foamed ceramic of a specific weight of 0.2 to 0.8, and the binding layer between the ceramic brick and the foam ceramic is an accelerated cement layer. However, such technique is found to have the following drawbacks: 1. The thermal conduction of the foamed ceramic is higher than the aerogel material or traditional organic foamed material, which is 4 to 5 times higher than the aerogel material, such that the heat loss is relatively higher; 2. Relevant organic foamed material generates obvious degradation and large amount of toxic gas at a high temperature above 350° C., such that the useful lifetime of foamed ceramic is affected.

In addition, Chinese Invention Patent Publication No. CN105025598A discloses an electric heating composite ceramic brick and a preparation method thereof, utilizing an electric heating film as a heating element, and its composition contains an organic bonding agent of 55 to 75 wt %, such as an organic resin of epoxy, polyurethane, or silicone. However, the drawback of such material relies in that the ceramic brick containing the organic binding agent cannot be used for a long time period under a high temperature environment above 350° C., and during the heating process under the high temperature, it is likely to generate degradation and release large amount of toxic gas.

Japanese Invention Patent Publication No. 200835648 discloses a porous material and a preparation method thereof. It mainly mixes a siloxane compound (such as tetraethoxysilane) or a silicate compound (such as sodium silicate) with an organic solvent and uses the sol-gel for synthesis, followed by using a modifier for modification in order to obtain the porous material. Accordingly, the surface hydrophilic functional group of the porous material is replaced with the hydrophobic functional group, in order to prevent the rupture of the aerogel due to the water surface tension. Its drawback is that the hydrophobic aerogel material obtained from such method cannot be used under a high temperature environment, and it starts to generate degradation and release large amount of toxic when the temperature reaches approximately 350° C.

Presently, most of the commonly used porous ceramic plates are of the foamed ceramics, honeycomb ceramics or particle ceramics structures, and all of them are silicate ceramic materials manufactured through high temperature heating. Such porous ceramic plates, essentially, belong to the high-density ceramic structure. Despite that the use of foaming technique is able to obtain a porous ceramic brick that is light weight and of high flame resistance, its heat resistance under high temperature is still weak such that the application effect of such material under a high temperature environment is still poor.

### SUMMARY OF THE INVENTION

An objective of the present invention is to overcome the drawbacks of a currently existing organic bonded porous ceramic board and a hydrophobic aerogel heat insulating blanket that cannot be used for a long time period under high temperature.

Another objective of the present invention is to add an inorganic fiber (such as ceramic fiber, rockwool, glass fiber cotton or carbon fiber cotton) into the aerogel such that it is able to directly improve the mechanical properties of pressure resistance and explosion resistance of aerogel related heat insulation products. In addition, the aerogel composite glue obtained from mixing can be directly sprayed or coated onto the exterior of various pipes, columns or equipment of irregular shapes, such that there is no need to spray aerogel powder between inorganic fiber blanket for the production of an aerogel heat insulating blanket.

Still another objective of the present invention is to use the inorganic adhesive solution as a binding agent between the hydrophilic aerogel particles and the material of inorganic fiber. In addition, after drying, it is able to further increase the porosity of the entire material as a whole, thereby reducing the material density and improving the material heat insulation capability. Furthermore, the entire product as a whole does not generate large carcinogenic and toxic substances under a high temperature environment, unlike the degradation of conventional organic binding agents. In addition, the use of the inorganic adhesive solution as a binding agent is able to increase the structural stability and heat insulation characteristic of the hydrophilic aerogel and the inorganic fiber under a high temperature environment. Moreover, most importantly, after the use of such material for a long time period under a high temperature environment, there is no issue of powdering and debris falling.

Still a further objective of the present invention is to utilize the high-temperature solvent replacement technique during the production process of the hydrophilic aerogel particles developed. It clearly indicates that it is able to reduce the solvent replacement or water cleaning speed in the traditional hydrophilic aerogel production process. Consequently, the production time is clearly reduced, such that the manufacturing cost is lowered and the production rate is increased.

Still another objective of the present invention is to utilize the traditional processing technique of spraying or extrusion for directly applying the composite glue composed of the aerogel and inorganic fiber on an inorganic fiber blanket in order to form a conventional aerogel heat insulating blanket. In addition, the composite glue composed of the aerogel and inorganic fiber can be combined with a conventional fiber blanket to form a multilayer structure. Moreover, a water repellent can also be added into the composite glue composed of the aerogel and inorganic fiber. Accordingly, aerogel heat insulating blankets equipped with the water repellent and high-temperature heat insulation characteristics can be mass produced continuously or in lots. Consequently, the acting force between the aerogel and the fabric of fiber blanket can be further enhanced, thereby increasing the product application value.

According to the present invention, a process technique for combining a hydrophilic aerogel, an inorganic fiber, and an inorganic adhesive is provided; wherein the hydrophilic aerogel particles is produced with the utilization of an improved sol-gel synthesis technique, and it is mixed with an inorganic fiber in an inorganic adhesive solution to form the composite glue composed of the aerogel and inorganic fiber. Such composite glue is of the facilitated processing characteristics of being soft and high adhesion. Furthermore, after drying and cross-linking, such composite glue is able to form an aerogel heat insulation board or an aerogel heat insulation brick with the characteristics of resistance to high temperature and high heat insulation.

Accordingly, the present invention provides a method for producing a composite glue composed of a hydrophilic aerogel, an inorganic fiber, and an inorganic adhesive, comprising the following steps: (1) mixing step: adding a siloxane compound into a mixing solvent in order to allow the siloxane compound to disperse in the mixing solvent to form a mixing solution; (2) hydrolysis step: adding an acid catalyst into the mixing solution to perform a hydrolysis reaction; (3) condensation step: adding a basic catalyst into the mixing solution to perform a condensation reaction; wherein in the condensation reaction process, a hydrophobic dispersing solvent is added therein, and the mixing solution is mixed at a high speed to form an aerogel wet gel of a uniform structure; or wherein in the condensation reaction process, a hydrophobic dispersing solvent is added therein, and the mixing solution is mixed at a high speed to form an aerogel wet gel of a uniform structure, followed by crushing the aerogel wet gel under a large-quantity hydrophobic solvent environment in order to crush the aerogel wet gel into particles of a particle size ranging from several hundred micrometers to several tenths of millimeters and being dispersed into the hydrophobic solvent; (4) aging step: performing aging on the aerogel wet gel under a specific temperature in order to further stabilize the aerogel wet gel; (5) high-temperature solvent replacement step: performing replacement of the hydrophobic dispensing solvent and a solvent in the aerogel wet gel under a condition of room pressure and high temperature until the aerogel wet gel becomes bluish transparent or completely transparent; (6) evaporation and drying step: using high-temperature distillation to remove or using a filter to remove the hydrophobic solvent, followed by performing high-temperature drying on the aerogel wet gel in order to obtain hydrophilic aerogel particles having a high porosity and a high specific surface area; and (7) composition step: using a mixing machine to mix the dried hydrophilic aerogel particles with an inorganic fiber with each other in order to form a uniformly dispersed inorganic mixture, followed by adding an inorganic adhesive solution into the inorganic mixture in order to allow the aerogel particles, the inorganic fiber and the inorganic adhesive solution with each other to form a hydrophilic composite glue with a viscosity and composed of the aerogel and the inorganic fiber, following by adding water, a thickener, a dispersant agent, or an aerogel powder to adjust the viscosity of the composite glue. Accordingly, the content of the aerogel is 15-40 v/v % of the composite glue, the content of the inorganic fiber is 10-35 v/v %, the content of the inorganic adhesive solution is 25-75 v/v %. In addition, the total content of the aerogel and the inorganic fiber in an aerogel heat insulation board obtained from the composite glue after drying is 25-90 wt %.

Furthermore, the siloxane compound comprises: a hydrophilic alkoxysilane, such as tetramethoxysilane (TMOS) or tetraethoxysilane (TEOS), mainly to provide a network bonding point density and to increase the softness and structural strength of the aerogel; and a small amount of hydrophobic alkoxysilane, such as methyltrimethoxysilane (MTMS) or methyltriethoxysilane (MTES), mainly to provide some hydrophobic characteristic for the aerogel in order to increase the structural stability of the aerogel structure.

Furthermore, the mixing solvent comprises a first component and a second component; the first component comprises one or a plurality of compositions selected from a group consisting of the following: water, alcohols and alkanes; the second component comprises one or a plurality of compositions selected from a group consisting of the following: an emulsifier and a surfactant.

Furthermore, the acid catalyst added in the hydrolysis step comprises one or a plurality of compositions selected from a group consisting of the following: sulfuric acid, phosphoric acid, nitric acid, and boric acid.

Furthermore, the basic catalyst added in the condensation step comprises one or a plurality of compositions selected from a group consisting of the following: sodium hydroxide, potassium hydroxide, sodium bicarbonate, and potassium bicarbonate.

Furthermore, the surfactant comprises one or a plurality of compositions selected from a group consisting of the following: cationic surfactant, anionic surfactant, zwitterionic surfactant and nonionic surfactant.

Furthermore, the hydrophobic dispensing solvent used in the condensation step, according to process needs, comprises a dispensing solvent formed by mixing a hydrophilic solvent and a hydrophobic solvent. In the condensation crushing reaction process, the addition of a large amount of dispensing solvent (such as one or a plurality of alcohols, aromatics, alkanes and organic halides) is able to allow the aerogel wet gel to have a large quantity of pores under the effect of the large-amount hydrophobic dispensing solvent. Moreover, through the use of the mixing ratio between the hydrophilic solvent and the hydrophobic solvent, the interaction between the molecules of the dispensing solvent and the molecules of the aerogel wet gel can be controlled, thereby controlling the microphase separation behavior of the aerogel wet gel molecules during the aggregation and binding process. Consequently, the molecular particle size and pore distribution characteristics of the aerogel wet gel formed can be controlled.

Furthermore, in this method, a conventional hydrophobic solvent replacement method under room pressure and high temperature is used to perform the solvent replacement in order to accelerate the solvent replacement efficiency and to reduce the aerogel production time. In this method, the solvent mixing and azeotropic effect between different hydrophilic and hydrophobic solvents is utilized in order to achieve solving mixing and azeotrope between the water molecules in the wet gel or other hydrophilic molecules and large-amount of hydrophobic solvent during the high-temperature solvent replacement process, thereby replacing the solvent in the wet gel swiftly until it is bluish transparent or completely transparent. Consequently, hydrophilic aerogel particles of low density and high porosity can be produced.

Furthermore, in this method, a conventional method under room pressure and high temperature is used to perform the solvent evaporation and drying. Once the drying is complete, hydrophilic aerogel particles of a particle size ranging from several hundreds of micrometers to several tenths of millimeters can be obtained. In general, the production process is simple and it is able to perform different hydrophilic functional group surface modification on the aerogel particles according to the substrate property. The production speed can be fast and can be reduced to be completed within 8 to 12 hours. In addition, it is able to continuously manufacture and produce aerogel particles with conventional hydrophilic functional group or special hydrophilic functional group, thereby increasing the production efficiency.

Furthermore, the transparent aerogel particles obtained from the solvent evaporation and drying under room pressure and high temperature can be directly mixed with an inorganic fiber in a mixing machine under a mixing force to mix with each other in order to form a uniformly dispersed aerogel inorganic mixture, followed by adding an inorganic adhesive therein in order to allow the aerogel particles, the inorganic fiber and the inorganic adhesive to interact with each other to form a viscous aerogel composite glue, following by adding water, a thickener, a dispersant agent, or an aerogel powder to adjust a viscosity of the aerogel composite glue. In the aerogel composite glue of the present invention, a content of the aerogel is 15-40 v/v %, a content of the inorganic fiber is 10-35 v/v %, a total content of the inorganic adhesive and water is 25-75 v/v %. The aerogel composite glue of the present invention has a high adhesion such that it can be filled into or coated onto high-temperature equipment of high-temperature furnace or internal combustion engine. Alternatively, the die casting method can be used to produce application products of aerogel heat insulation bricks or boards. The total content of the aerogel and inorganic fiber in an aerogel heat insulation brick or board is approximately 25-90 wt %.

Furthermore, the total content of the aerogel and inorganic fiber in an aerogel heat insulation board formed after the drying of the aerogel composite glue is approximately 90 wt %, and it is able to withstand a temperature above 800° C. Under the room temperature and a temperature below 500° C., its thermal conductivities are 0.04 W/mK and 0.095 W/mK respectively.

Furthermore, the inorganic fiber can be one or a plurality of materials selected from a group consisting of the following: inorganic materials of ceramic fiber, glass fiber, carbon fiber, oxidized fiber and rockwool fiber.

The present invention is of the following technical effects:

1. The production method of the present invention utilizes the condensation step such that under the effect of the hydrophobic dispensing solvent, the hydrophilic solvent in the aerogel wet gel interacts and mixes with the hydrophobic dispensing solvent in order to allow the wet gel surface layer to undergo gelation quickly such that a dense aerogel shell layer is formed. In addition, the hydrophobic dispensing solvent is also infiltrated into the aerogel wet gel to promote the gelation. Furthermore, due to the infiltration of the hydrophobic solvent, the liquid-solid phase-separation occurs to promote the wet gel to generate a great quantity of nanopores in the mesoporous structure. Moreover, after the hydrophobic solvent infiltrates into the wet gel, it also dissolves with the ethanol and water; therefore, the interface tension of water molecules is changed, such that the contractibility of the aerogel wet gel structure can be significantly reduced in the subsequent aging and drying process in order to generate hydrophilic aerogel particles with high porosity. Accordingly, it is able to significantly enhance the heat insulation and fireproof performance of the hydrophilic aerogel particles. In addition, the aerogel particle content in the mixing material can also be increased such that the practicality of the aerogel is increased.

2. For the hydrophilic aerogel particles obtained from the production method of the present invention, its density, particle size, porosity and pore size can be controlled based on the production criterion, such as content of the hydrophilic alkoxysilane, content of the hydrophobic alkoxysilane, content of the solvent, content of the acid catalyst or basic catalyst, content of the surfactant, composition and content of the hydrophobic dispensing solvent, composition or content of the hydrophobic solvent, solvent replacement temperature, and mixing speed.

3. For the production method of the present invention, in the condensation and dispersion step, crushing and quick mixing are performed under large amount of hydrophobic solvent, following which drying is performed to remove the hydrophobic solvent. Consequently, hydrophilic aerogel particles of a particle size ranging from several hundreds of micrometers to several tenths of millimeters can be obtained. The hydrophilic aerogel particles generated are of excellent dispersity and can be mixed in a substrate at a high content while maintaining high porosity at the internal of the aerogel in the substrate, thereby enhancing the heat insulation and fireproof properties of the hydrophilic aerogel particles in different types of substrates.

4. The present invention adopts the control of the criterion of the solvent content and temperature in the high-temperature solvent replacement step to reduce the overall aerogel replacement time, and the production of a large quantity (volume of approximately 500 to 5000 L) of hydrophilic aerogel particles can be produced completely within a time period of 12 to 24 hours. Consequently, the production efficiency of aerogel is increased.

5. The present invention uses the hydrophilic aerogel particles mixed with the inorganic fiber along with the use of the inorganic adhesive solution to form a heat insulating composite glue composed of the aerogel, the inorganic fiber, and the inorganic adhesive for high temperature use. Its relevant products can be used for a long time period at a temperature above 600° C., or is able to achieve heat insulation for a short time period under an extremely high temperature environment of 1000° C.

### BRIEF DESCRIPTION OF THE DRAWINGS

FIG. 1 is a flowchart of the steps of the method for producing a hydrophilic aerogel composite glue according to an embodiment of the present invention;

FIG. 2 is a photo image showing the outer appearance of the hydrophilic aerogel particles produced based on the method of the present invention;

FIG. 3 is a photo image showing the outer appearance of the hydrophilic aerogel particles produced based on the method of the present invention;

FIG. 4 is a scanning electronic microscope photo image showing the hydrophilic aerogel particles produced based on the method of the present invention;

FIG. 5 is a photo image showing a high-temperature and heat-insulating aerogel brick of the dimension of 10.5 cm×10.5 cm×9.5 cm; and

FIG. 6 is a temperature change graph of a rear side of a high-temperature and heat-insulating aerogel brick of a thickness of 3 cm being heated for 3 hours under the temperature condition of 1200° C.; wherein the ratio refers to the volume ratio.

### DETAILED DESCRIPTION OF THE INVENTION

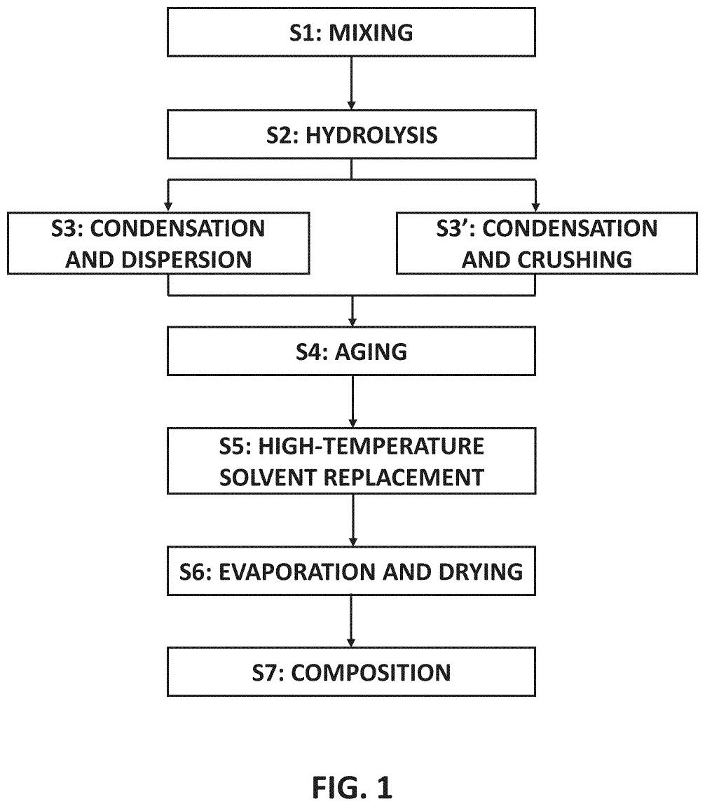

Please refer to FIG. 1, showing a method for producing a composite glue composed of a hydrophilic aerogel, an inorganic fiber, and an inorganic adhesive of the present invention, comprising the following steps: mixing step (S1), hydrolysis step (S2), condensation and dispersion step (S3) or condensation and crushing step (S3′), aging step (S4), high-temperature solvent replacement step (S5), evaporation and drying step (S6), and composition step (S7). Accordingly, it is able to be applied to the production of an aerogel heat insulation brick with high temperature resistance.

Mixing step (S1): A siloxane compound and a mixing solvent are mixed. The siloxane compound comprises one or a plurality of compounds selected from a group consisting of the following: hydrophilic alkoxysilane, such as tetramethoxysilane (TMOS) or tetraethoxysilane (TEOS), and a small amount of hydrophobic alkoxysilane, such as methyltrimethoxysilane (MTMS) or methyltriethoxysilane (MTES); the above hydrophobic molecules, in the present content, are mainly to provide some hydrophobic characteristic for the aerogel in order to increase the structural stability of the aerogel structure. In addition, another hydrophilic alkoxysilane of an extremely small amount can be further added: R-alkoxysilane, and it is mainly to perform the aerogel microstructure modification and control the functional group content; wherein R— refers to a hydrophilic functional group, comprising: —COOH, —NH₂, —NH—, —OH, —CONH— or —COH—COH; and a carbon number of the hydrophilic functional group is from C1 to C8. For calculation based on the total content of the mixing solution, the total content of the siloxane compound is 3.0 mol % to 60.0 mol %; wherein the hydrophobic alkoxysilane content is 0.05 mol % to 6.0 mol %, and the solvent content is 97.0 mol % to 40.0 mol %.

The solvent used in the mixing step (S1) can be water, conditioned water, deionized water, secondary water, C1 to C8 alcohols, C1 to C8 alkanes, polymer emulsifier or surfactant. To be more specific, the mixing agent is water, conditioned water, deionized water, ethanol, toluene, n-hexane, cyclohexane, polyvinyl alcohol, or hexadecyl trimethyl ammonium chloride.

Hydrolysis step (S2): An acid catalyst is added into the mixing solution to perform a hydrolysis reaction. The ratio between the total content of siloxane compound and the acid catalyst is 1:0.5 to 1:0.0001. In addition, when it contains certain specific R-alkoxysilane, it is not necessary to add the acid catalyst, but water can be used directly for the hydrolysis. Furthermore, when the ratio between the total content of the siloxane compound and the acid catalyst is 1:0.0001, the hydrolysis reaction time requires 360 minutes. When the ratio between the total content of the siloxane compound and the acid catalyst is 1:0.5, the hydrolysis reaction time requires 5 minutes. Therefore, it can be understood that the hydrolysis time is reduced along with the increase of the acid catalyst content.

Condensation and dispersion step (S3) or condensation and crushing step (S3′): A basic catalyst is added into the mixing solution to perform a condensation reaction. The mole ratio between the acid catalyst and basic catalyst is from 1:1 to 1:4. In the mixing solution, increase of the basic catalyst content is able to significantly reduce the condensation reaction time (i.e. The gelation time). When the mole ratio of the acid catalyst and basic catalyst is 1:1, gelation time is approximately 1,200 minutes. When the mole ratio of the acid catalyst and basic catalyst is 1:3, gelation time is reduced to approximately 3-5 minutes. Therefore, the basic catalyst content can be adjusted to adjust the gelation time.

Before the condensation reaction is near completion, the mixing solution forms a solution-like sol. In the condensation and dispersion step (S3), when the mixing solution is controlled to be under the solution-like sol condition, add a large amount of hydrophobic dispersing solvent of incompatible system is added, and fast mixing at a rotational speed between 100 rpm and 500 rpm is performed, in order to allow the mixing solution to be under the acting force of the mixing solvent effect of the dispersing solvent, and to allow the hydration force of the water molecules in the mixing solution to be suppressed, following which through gelation, it forms a hydrophilic aerogel wet gel. The volume ratio of the mixing solvent and the hydrophobic dispersing solvent is between 1:0.05 and 1:0.5. As the content of the hydrophobic dispersing solvent is higher, the contraction ratio of the aerogel particles subsequently produced is lower, the macroscopic phase separation behavior is more severe and it is of an opaque appearance; however, its structural porosity is relatively higher and the density is lower. In the condensation and crushing step (S3′), under the condition of large amount of hydrophobic solvent, crushing is further performed on the hydrophilic aerogel wet gel in order to crush the wet gel into particles of a particle size ranging from several hundreds of micrometers to several tenths of millimeters and being dispersed in the hydrophobic solvent.

In the condensation and dispersion step (S3) or the condensation and crushing step (S3′), the hydrophobic dispersing solvent can be C2 to C4 alcohols, C6 to C12 aromatics, C5 to C9 alkanes, or C7 to C12 aromatic alcohols. To be more specific, the hydrophobic dispersing solvent is ethanol, hexane, cyclohexane, pentane, benzene, toluene, benzyl alcohol or phenethyl alcohol.

Aging step (S4): Aging is performed when the hydrophilic aerogel wet gel structure is under a specific temperature (such as between 35 and 80° C., and preferably between 40 and 50° C.) in order to stabilize the hydrophilic aerogel wet gel structure.

High-temperature solvent replacement step (S5): The condition of room pressure and high temperature (such as between 50 and 160° C.) is used to perform solvent replacement on the wet gel. In the high-temperature solvent replacement step (S5), the miscibility between the hydrophilic and hydrophobic solvents is utilized in order to achieve the solvent mixing and azeotropic effect between the water molecules in the wet gel or other hydrophilic molecules and large-amount of hydrophobic solvent, thereby replacing the solvent in the wet gel swiftly until it is bluish transparent or completely transparent. Therefore, hydrophilic aerogel particles of low density and high porosity can be produced subsequently.

Evaporation and drying step (S6): After high-temperature distillation is used to remove the aforementioned remaining hydrophobic solvent or filter is used to remove the aforementioned remaining hydrophobic solvent, the wet gel is dried quickly under the condition of temperature between 60 and 160° C. and under room pressure, in order to obtain hydrophilic aerogel particles of a high density. Subsequently, a fluidized bed dryer, a constant temperature oven, a drum dryer, a mixing dryer, a spray dryer or a vacuum dryer at a temperature between 90 and 250° C. is used to dry the aerogel particles in order obtain dry hydrophilic aerogel particles.

Accordingly, hydrophilic aerogel particles of a particle size ranging from several hundreds of micrometers to several tenths of millimeters can be produced. In addition, through the technique of the present invention, it is able to produce hydrophilic functional group modified aerogel particles, and they can be mixed with the material of, such as, cement, cement paint, adhesive, or paint in order to be applied onto various types of fireproof and heat insulation products, thereby enhancing the application property of the aerogel particles. Particularly, the aerogel particles produced can be applied to high-temperature resistant aerogel heat insulation boards or bricks production and application.

Composition step (S7): Furthermore, the transparent aerogel particles can be directly mixed with an inorganic fiber in a mixing machine under a mixing force to mix with each other in order to form a uniformly dispersed inorganic mixture, followed by adding an inorganic adhesive therein in order to allow the aerogel particles, the inorganic fiber and the inorganic adhesive to interact with each other to form a viscous aerogel composite glue, following by adding water, a thickener, a dispersant agent, or an aerogel powder to adjust a viscosity of the aerogel composite glue in order to obtain the aerogel composite glue.

The inorganic adhesive used in the composition step (S7) comprises one or a plurality of compounds selected from a group consisting of the following: phosphate, silicate, sulfate, borate, metal oxide. To be more specific, the phosphate refers to, such as, zirconium phosphate or phosphoric acid-cooper oxide. The silicate refers to, such as, aluminum silicate or sodium silicate. The metal oxide refers to a metal oxide containing a copper, aluminum, zirconium, yttrium or lanthanide element.

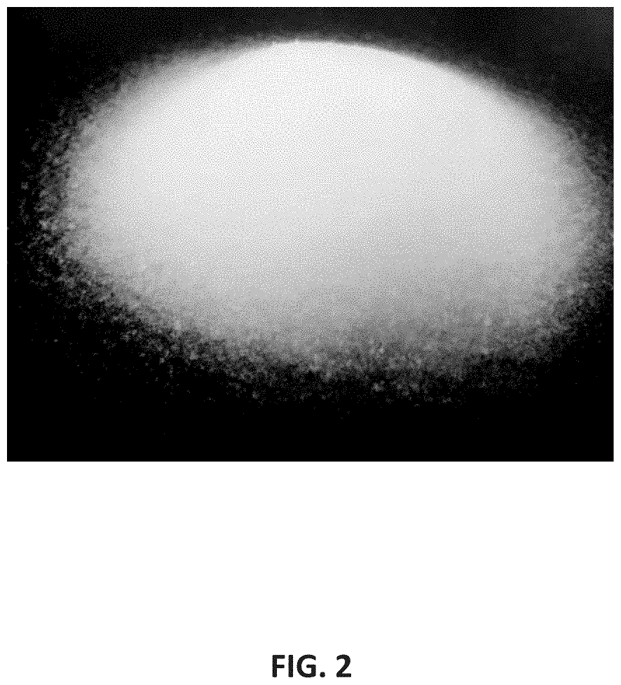

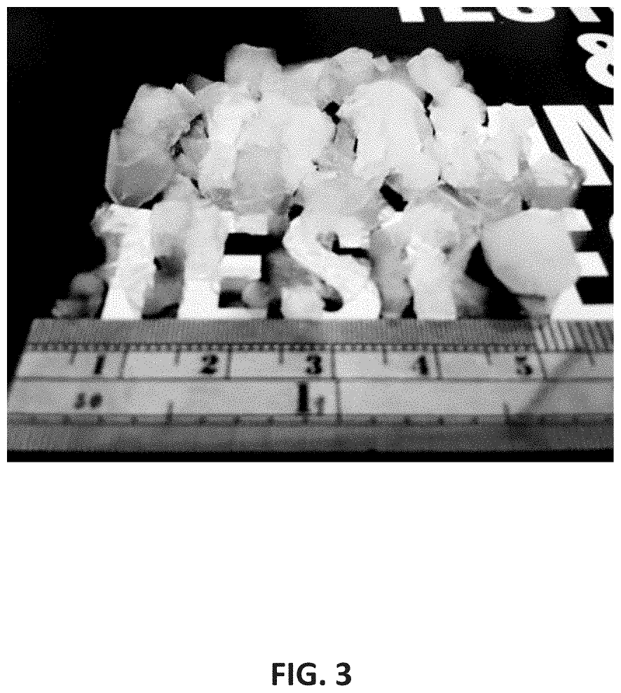

Please refer to FIG. 2 and FIG. 3, showing the outer dimensions of the hydrophilic aerogel particles observed by using a conventional camera. In FIG. 2, it shows that the micron-sized hydrophilic aerogel particles have a dimension of approximately 50 micrometers to 200 micrometers. In FIG. 3, it shows that the millimetre-sized hydrophilic aerogel particles have a particle size of approximately 3 millimeters to 20 millimeters.

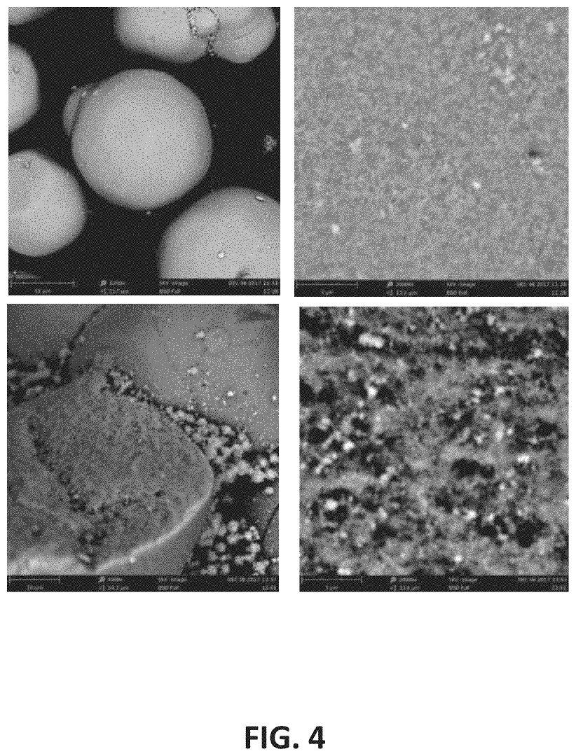

Please refer to FIG. 4. A scanning electronic microscope is used to observe the microstructure of the hydrophilic aerogel particles, and their surfaces and the internal contain a great quantity of pores.

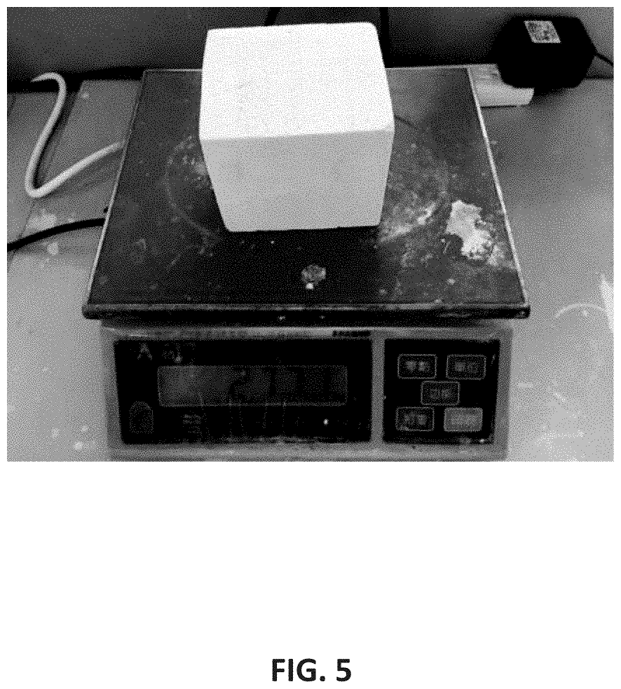

Please refer to FIG. 5, showing the outer appearance of a high-temperature and heat-insulating aerogel brick of the dimension of 10.5 cm×10.5 cm×9.5 cm produced. As shown in the photo image, its weight is 277.1 g. After calculation, it can be obtained that the density of the high-temperature and heat-insulating aerogel brick is 0.265 g/cm³, such that it has an excellent light-weight effect.

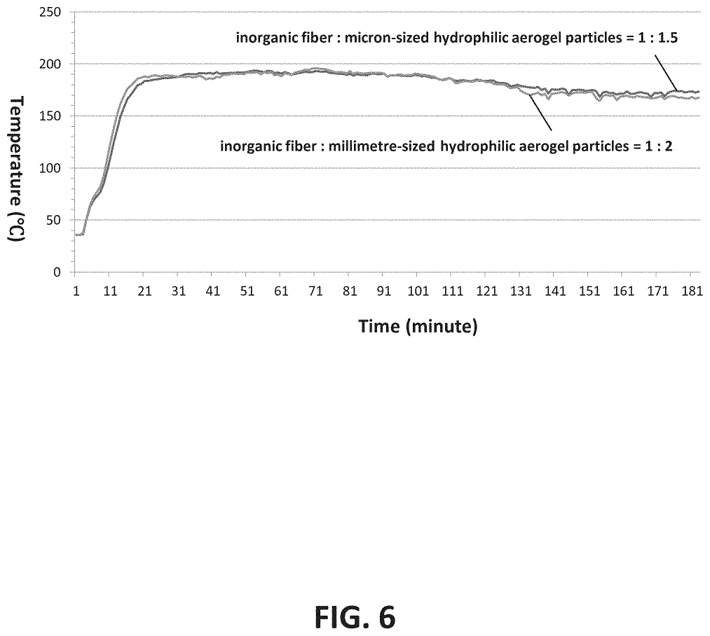

Please refer to FIG. 6, in which the comparison on the temperatures of the rear side of a high-temperature and heat-insulating aerogel brick of a thickness of 3 cm being heated for 3 hours under the temperature condition of 1200° C. is performed. From the comparison result, it indicates that when the room temperature is 25° C., the rear side temperature of the high-temperature and heat-insulating aerogel brick after being heated for 3 hours under 1200° C. is approximately 175° C., demonstrating that the product produced from the method according to this embodiment of the present invention has excellent properties of high temperature resistance and heat insulation.

In view of the descriptions of the aforementioned embodiments, the manufacturing, application and technical effects of the present invention can be sufficiently understood. However, it shall be noted that the aforementioned embodiments refer to the preferred embodiments of the present invention only such that they shall not be used to limit the scope of the present invention, i.e. All simple equivalent changes and modifications made based on the claims and the content of the description of the present invention shall be considered to be within the scope of the present invention.

What is claimed is:

1. A method for producing a composite glue composed of a hydrophilic aerogel, an inorganic fiber, and an inorganic adhesive, comprising:
mixing step: mixing a siloxane compound and a mixing solvent to form a mixing solution;
hydrolysis step: adding an acid catalyst into the mixing solution to perform a hydrolysis reaction;
condensation step: adding a basic catalyst into the mixing solution to perform a condensation reaction; wherein in the condensation reaction process, a hydrophobic dispersing solvent is added therein, and the mixing solution is mixed at a high speed to form an aerogel wet gel of a uniform structure; or
wherein in the condensation reaction process, a hydrophobic dispersing solvent is added therein, and the mixing solution is mixed at a high speed to form an aerogel wet gel of a uniform structure, followed by crushing the aerogel wet gel under a large-amount hydrophobic solvent environment in order to crush the aerogel wet gel into particles of a particle size ranging from several hundreds of micrometers to several tenths of millimeters and being dispersed into the hydrophobic solvent;
aging step: performing aging on the aerogel wet gel under a specific temperature in order to further stabilize the aerogel wet gel;
high-temperature solvent replacement step: performing replacement of the hydrophobic dispensing solvent and a solvent in the aerogel wet gel under a condition of room pressure and high temperature until the aerogel wet gel becomes bluish transparent or completely transparent;
evaporation and drying step: using high-temperature distillation to remove or using a filter to remove the hydrophobic solvent, followed by performing high-temperature drying on the aerogel wet gel in order to obtain hydrophilic aerogel particles having a high porosity and a high specific surface area; and
composition step: using a mixing machine to mix the dried hydrophilic aerogel particles with an inorganic fiber with each other in order to form a uniformly dispersed inorganic mixture, followed by adding an inorganic adhesive solution into the inorganic mixture in order to allow the aerogel particles, the inorganic fiber and the inorganic adhesive solution to interact with each other to form a hydrophilic composite glue with a viscosity and composed of the aerogel and the inorganic fiber, following by adding a water, a thickener, a dispersant agent, or an aerogel powder to adjust the viscosity of the composite glue.

2. The method for producing a composite glue composed of a hydrophilic aerogel, an inorganic fiber, and an inorganic adhesive according to claim 1, wherein the siloxane compound comprises: a first hydrophilic alkoxysilane, a second hydrophilic alkoxysilane of a small amount, and a hydrophobic alkoxysilane of a small amount; the first hydrophilic alkoxysilane is selected from tetramethoxysilane (TMOS) or tetraethoxysilane (TEOS); the hydrophobic alkoxysilane is selected from methyltrimethoxysilane (MTMS) or methyltriethoxysilane (MTES); the second hydrophilic alkoxysilane is R-alkoxysilane, wherein R— refers to a hydrophilic functional group and comprises: —COOH, —NH₂, —NH—, —OH, —CONH— or —COH—COH; and a carbon number of the hydrophilic functional group is from C1 to C8.

3. The method for producing a composite glue composed of a hydrophilic aerogel, an inorganic fiber, and an inorganic adhesive according to claim 1, wherein the mixing solvent comprises a first component and a second component; the first component comprises one or a plurality of compositions selected from a group consisting of the following: water, alcohols and alkanes; the second component comprises one or a plurality of compositions selected from a group consisting of the following: an emulsifier and a surfactant.

4. The method for producing a composite glue composed of a hydrophilic aerogel, an inorganic fiber, and an inorganic adhesive according to claim 1, wherein the hydrophobic dispensing solvent refers to C2 to C4 alcohols, C6 to C12 aromatics, C5 to C9 alkanes, or C7 to C12 aromatic alcohols; the alcohols refer to ethanol; the alkanes refer to hexane, cyclohexane or pentane; the aromatics refer to benzene or toluene; the aromatic alcohols refer to benzyl alcohol or phenethyl alcohol.

5. The method for producing a composite glue composed of a hydrophilic aerogel, an inorganic fiber, and an inorganic adhesive according to claim 1, wherein the solvent replacement step is performed at a temperature between 50 to 160° C. and under room pressure.

6. The method for producing a composite glue composed of a hydrophilic aerogel, an inorganic fiber, and an inorganic adhesive according to claim 1, wherein in the evaporation and drying step, the high-temperature distillation refers to a quick drying under a condition of a temperature between 60 and 160° C. and room pressure; wherein the high-temperature drying refers to using a fluidized bed dryer, a constant temperature oven, a drum dryer, a mixing dryer, a spray dryer or a vacuum dryer at a temperature between 90 and 250° C. to perform drying.

7. The method for producing a composite glue composed of a hydrophilic aerogel, an inorganic fiber, and an inorganic adhesive according to claim 2, wherein a density, a particle size, a porosity and a pore size of the aerogel particles are controlled based on the following criterion: a content of the first hydrophilic alkoxysilane, a content of the second hydrophilic alkoxysilane, a content of the hydrophobic alkoxysilane, a content of the solvent, a viscosity of the solvent, a content of the acid catalyst, a content of the basic catalyst, a type or a content of the hydrophobic dispensing solvent, a type or a content of the hydrophobic solvent, a solvent replacement temperature, and a mixing speed.

8. The method for producing a composite glue composed of a hydrophilic aerogel, an inorganic fiber, and an inorganic adhesive according to claim 1, wherein the composition step is replaced by: using a mixing machine under a mixing force to mix the dried hydrophilic aerogel particles directly with an inorganic fiber to form a uniformly dispersed inorganic mixture, followed by adding an inorganic adhesive into the inorganic mixture in order to allow the aerogel particles, the inorganic fiber and the inorganic adhesive to interact with each other to form a viscous aerogel composite glue, following by adding a water, a thickener, a dispersant agent, or an aerogel powder to adjust a viscosity of the aerogel composite glue.

9. The method for producing a composite glue composed of a hydrophilic aerogel, an inorganic fiber, and an inorganic adhesive according to claim 8, wherein the inorganic adhesive is selected from: phosphate, silicate, sulfate, borate, or metal oxide; the phosphate refers to zirconium phosphate, phosphoric acid-cooper oxide; the silicate refers to aluminum silicate or sodium silicate; the metal oxide refers to an oxide containing a copper, aluminum, zirconium, yttrium or lanthanide element.

10. The method for producing a composite glue composed of a hydrophilic aerogel, an inorganic fiber, and an inorganic adhesive according to claim 1, wherein a content of the aerogel is 15-40 v/v % of the composite glue, a content of the inorganic fiber is 10-35 v/v %, a content of the inorganic adhesive solution is 25-75 v/v %, and a total content of the aerogel and the inorganic fiber in an aerogel heat insulation board obtained from the composite glue after drying is 25-90 wt %.
